(19) United States
(12) Patent Application Publication
(10) Pub. No.: US 2010/0328261 A1
(43) Pub. Date: Dec. 30, 2010

(54) CAPACITIVE TOUCHPAD CAPABLE OF OPERATING IN A SINGLE SURFACE TRACKING MODE AND A BUTTON MODE WITH REDUCED SURFACE TRACKING CAPABILITY

(76) Inventors: Richard D. Woolley, Orem, UT (US); Dale J. Carter, Orem, UT (US)

Correspondence Address: MORRISS OBRYANT COMPAGNI, P.C., 734 EAST 200 SOUTH, SALT LAKE CITY, UT, 84102, US

(21) Appl. No.: 12/818,021

(22) Filed: Jun. 17, 2010

Related U.S. Application Data
(60) Provisional application No. 61/220,143, filed on Jun. 24, 2009.

(51) Int. Cl. G06F 3/045

(52) U.S. Cl. 345/174

(57) ABSTRACT

A touchpad that operates in two modes, wherein a first mode enables the entire surface of the touchpad to operate in a typical detection single object detection and tracking mode to track the movement of a conductive object such as a finger anywhere on the surface of the touchpad and perform typical touchpad operations such as cursor control, and a second mode of operation wherein a button region of the touchpad is no longer used for the tracking of movement of a finger on the surface of the touchpad, but is instead dedicated to a button function if a finger on the touchpad pushes with sufficient force to activate a switch underneath the touchpad.

### CROSS REFERENCE TO RELATED APPLICATIONS

This document claims priority to and incorporates by reference all of the subject matter included in the provisional patent application docket number 4631.CIRQ.PR, having Ser. No. 61/220,143.

### BACKGROUND OF THE INVENTION

1. Field of the Invention

This invention relates generally to touchpad technology. More specifically, an apparently seamless touchpad surface can operate in two distinct modes, wherein a first mode enables the touchpad to operate with the entire surface being available for tracking of an object, and a second mode enables a portion of the touchpad surface to be unavailable for tracking when it is being used as a button.

2. Description of Related Art

Hereinafter, the term touchpad shall refer to any touch and/or proximity sensitive surface such as a touch screen, touch panel, surface capacitance panel and any other similarly operating devices. There are several designs for capacitance sensitive touchpads. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of-a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

The underlying technology for the CIRQUE® Corporation touchpad is based on capacitive sensors. However, other touchpad technologies can also be used for the present invention. These other proximity-sensitive and touch-sensitive touchpad technologies include electromagnetic, inductive, pressure sensing, electrostatic, ultrasonic, optical, resistive membrane, semi-conductive membrane or other finger or stylus-responsive technology.

The concept of placing a mechanical switch under a touchpad is well known in the prior art. However, implementation has required one of two systems. A first system has used a dedicated button area that cannot be used for general purpose tracking purposes. Thus the button area only functions as a button and cannot serve in a multi-functional capacity.

A second system requires multi-touch capabilities. Multi-touch tracking of objects on a touchpad requires substantial dedication of touchpad resources in order to actively detect and track the locations of multiple objects on a touchpad.

Accordingly, it would be an advantage over the prior art to provide a touchpad that can provide dynamically allocated tracking and button function regions on the same touchpad, without having to provide multi-touch capabilities.

### BRIEF SUMMARY OF THE INVENTION

In a first embodiment, the present invention is a touchpad that operates in two modes, wherein a first mode enables the entire surface of the touchpad to operate in a typical detection single object detection and tracking mode to track the movement of a conductive object such as a finger anywhere on the surface of the touchpad and perform typical touchpad operations such as cursor control, and a second mode of operation wherein a button region of the touchpad is no longer used for the tracking of movement of a finger on the surface of the touchpad, but is instead dedicated to a button function if a finger on the touchpad pushes with sufficient force to activate a mechanical switch underneath the touchpad.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram showing the components of a first embodiment of a touchpad that is found in the prior art, and which is adaptable for use in the present invention.

FIG. 2 is a top view diagram showing two regions of a touchpad and a mechanical switch disposed under the touchpad in a first embodiment of the present invention.

FIG. 3 is a top view diagram showing an alternative embodiment of the present invention having a primary region and a button region divided into two buttons. The button region can be divided into further buttons.

FIG. 4 is a top view diagram that illustrates a drag function using two fingers.

FIG. 5 is a top view diagram that illustrates another alternative embodiment of the present invention having two button regions and a primary tracking region.

FIG. 6 is a top view diagram that illustrates a new location of the mechanical switch underneath the touchpad.

FIG. 7 shows implementation of electrodes using a single sensor circuit that has two separate sense lines that can be dedicated to two separate regions.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The first embodiment of the invention is a capacitance sensitive touchpad, such as the one that is provided by Cirque® Corporation described above, and in subsequent devices on the market. However, the present invention can be adapted to other technologies.

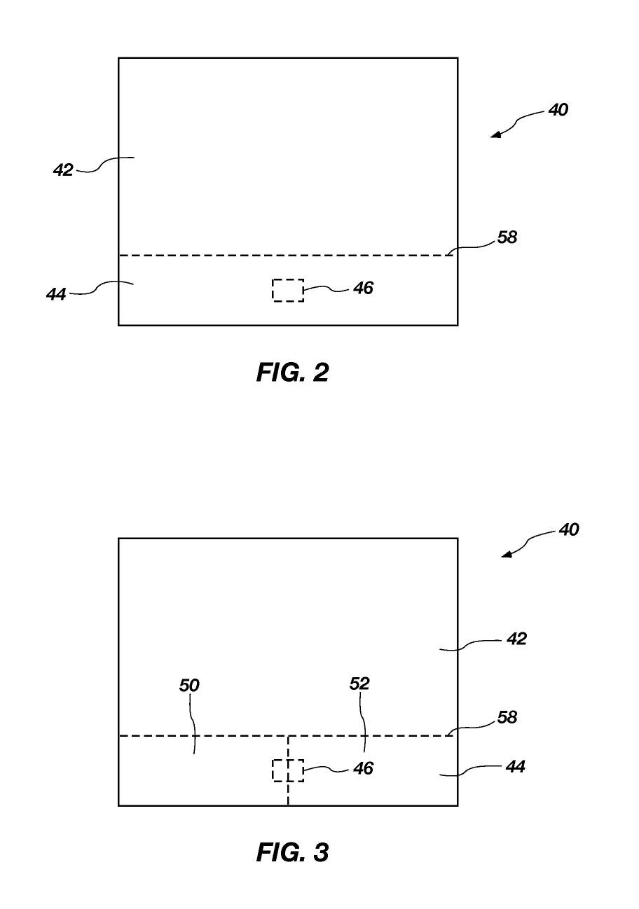

FIG. 2 is a top view of the surface of a touchpad 40. The touchpad 40 includes a primary sensor region 42 and a secondary sensor region 44. The primary sensor region 42 always functions as an area that is dedicated to the detecting and tracking of a conductive object, hereinafter to be referred to as a finger.

The secondary sensor region 44 is capable of performing at least two functions. A first function is to detect and track an object on the touchpad 40, just as the primary sensor region 42 is designed to do. However, a second function is to operate as a button or switch, such as a button or switch that is common in a computer mouse for performing the common left and right mouse click functions. Specifically, at least one mechanical switch 46 or other type of activating mechanism is disposed under the secondary sensor region 44.

The secondary sensor region 44 is shown as being smaller than the primary sensor region 42, and on a bottom portion of the touchpad 40. This specific example is for illustration purposes only and should not be considered a limitation on the design of the first embodiment of the present invention. The secondary sensor region 44 can be larger than the primary sensor region 42, and can be disposed anywhere on the touchpad 40, such as along a top edge, a right edge, a left edge, centrally located, offset from the center, or any combination of these areas.

The dashed line 58 in FIG. 2 that is shown separating the primary sensor region 42 from the secondary sensor region 44 may or may not be visible to the user. This division between the sensor regions 42, 44 can be made hidden, visible, provide tactile feedback, or be made visible and provide tactile feedback to the user.

A dashed outline is used to indicate the location of a mechanical switch 46 underneath the touchpad 40. The size and exact location of the mechanical switch 46 can be changed, and should not be considered limited to what is shown. This is for illustration purposes only. Preferably, the mechanical switch 46 is disposed in an area where pressing on the secondary sensor area 44 will activate the switch 46.

The mechanical switch 46 can operate as a toggle switch that enables the touchpad to switch between the two different modes of operation of the touchpad 40. A visual indicator can also be used to provide information to the user regarding which mode of operation of the touchpad 40 is currently active.

In a first mode of operation, the touchpad 40 is in a detection and tracking mode of operation where the primary sensor region 42 and the secondary sensor region 44 are both capable of tracking the movement of a conductive object on the entire surface of the touchpad. Movement from the primary sensor region 42 to the secondary sensor region 44 and back again are seamless operations. For example, if a cursor is being moved, there is no interruption of movement or any other visual indicator that a finger has moved from one region to the other.

When the user desires to switch to a second mode of operation, ideally the user presses down on the touchpad in a specific area such as within the secondary sensor region 44, or it may be possible to press down anywhere on the touchpad 40. The purpose of pressing down is to activate the mechanical switch 46. If the touchpad 40 is operating in a first mode of operation, then actuating the mechanical switch 46 will cause the touchpad to toggle to the second mode of operation. The second mode of operation is only active so long as pressure is applied to the mechanical switch so it is activated. Releasing pressure from the mechanical switch 46 should toggle the touchpad back to the first mode of operation.

In an alternative embodiment, activating the mechanical switch puts the touchpad into a second mode of operation, but releasing pressure does not cause the touchpad to revert back to the first mode of operation. That change would require another pressing of the mechanical switch 46.

In another alternative embodiment, the mechanical switch 46 is a non-mechanical switch that is also activated by pressing down on the secondary sensor area 44, or in another area of the touchpad 40. The benefit of using a mechanical switch is that the user receives haptic feedback in the form of a physical response that is possible when using a mechanical switch. The haptic feedback can be, for example, a clicking sensation that is often associated with a physical switch. Another response could be auditory, or haptic feedback in combination with an auditory response such as an audible clicking sound. However, even a non-mechanical switch can be associated with an audible clicking sound.

In the preferred mode of operation, the touchpad 40 is always in a first mode of operation when the mechanical switch 46 is not being pressed, and switches or toggles to a second mode of operation only so long as the user is pressing down on the touchpad. Thus, the user only presses down on the touchpad 40 when a finger is already within the second sensor region 44. Furthermore, if there is more than one button within the second sensor region 44, then the finger should already be within the area of the desired button before the user presses down on the touchpad 40. Pressing down on the button will cause whatever function is controlled by that button to be executed. The user must then release pressure on the touchpad 40 and allow the mechanical switch 46 to be released in order for the secondary sensor region 40 to return to a first mode of operation where the entire touchpad 40 is operating as a movement tracking device.

FIG. 3 is an alternative embodiment of the present invention. The secondary sensor region 44 can be divided into multiple distinct regions that represent different buttons. For example, FIG. 3 shows that the secondary sensor region 44 is divided into two regions representing two distinct buttons 50 and 52. The secondary sensor region 44 may also be divided into more regions representing more buttons. The number of buttons in a secondary sensor region should not be considered a limiting factor of the present invention.

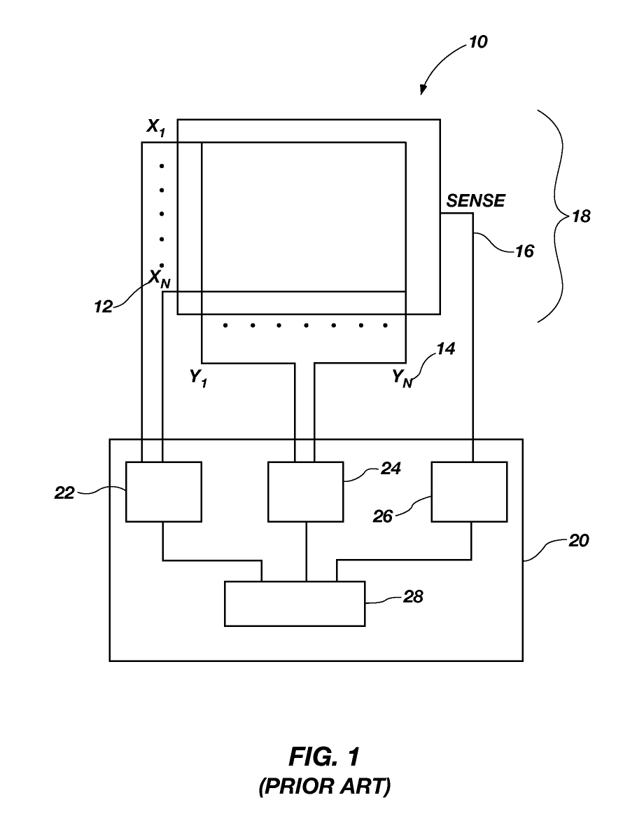

Activation of the secondary sensor region 44 with multiple buttons is done the same way as shown in FIG. 1, using a mechanical switch beneath the touchpad 40. As before, the mechanical switch can be disposed anywhere under the touchpad 40. However, the mechanical switch 46 is shown under the secondary sensor region 44.

Once the touchpad is in the second mode of operation because the user is pressing on the touchpad 40 and the button or buttons in the secondary sensor region 44 are activated, the present invention determines which button function to activate based on the location of an object that is detected within a button region. Thus, if a user places a finger anywhere within the region defined as button 50, the function associated with that button is executed after the mechanical switch 46 is activated.

When a finger is touching the touchpad 40 but not pressing hard enough to activate the mechanical switch 46, then the touchpad is in a first mode of operation and operates as a typical touchpad. Typical operation is defined here as the detection and tracking of a single object on the surface of the touchpad 40.

However, when a finger is touching a button in the secondary sensor region 44 and pressing down on the touchpad 40 so that the mechanical switch 46 is activated, the operation of the touchpad changes. The button regions defined by the secondary sensor region 44 cease to function as part of the general purpose touchpad function of detection and tracking of an object on the touchpad 40. In this second mode of operation, the primary sensor region 42 is the only region that is now detecting and tracking the motion of a finger to perform touchpad functions such as cursor control. The secondary sensor region 44 no longer operates as part of the general detection and movement tracking of the primary sensor region 42. Touchpad sensor hardware associated with the touchpad 40 first determines in which button region a finger is located. In this example, the finger is located in either button 50 or 52. In essence, the primary sensor region 42 and the secondary sensor region 44 are now functioning as distinct and separate touchpads, and movement of the finger within the secondary sensor region 44 will not cause movement of a cursor, or whatever function is being performed by the primary sensor region 42.

It may seem that having the secondary mode of operation only active when pressing down on the touchpad serves no useful purpose because the finger is also pressing down on a button in the secondary sensor region 44, however, this mode of operation becomes useful when using more than one finger on a touchpad 40.

To illustrate this concept further, while a finger is located in either button 50 or 52, and pressing hard enough on the touchpad 40 to activate the mechanical switch 46 beneath the touchpad, the primary sensor region 42 can still be used to detect and track a different finger. One useful function that can now be performed is the dragging of an object on a display screen.

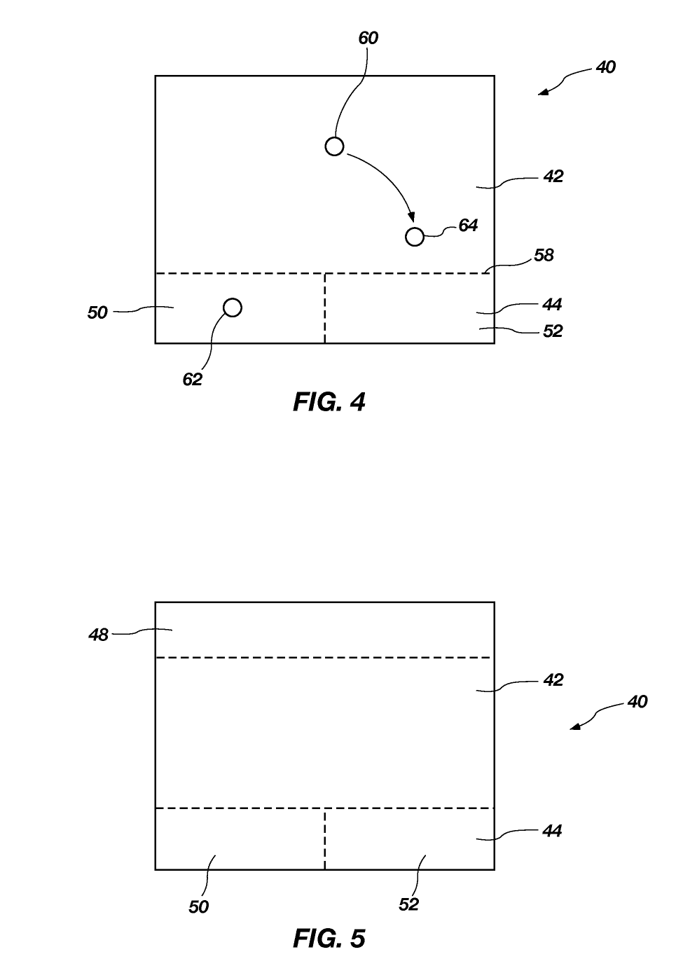

For example, FIG. 4 shows a touchpad 40. Consider a first finger that is moving across the touchpad 40 until reaching location 60. It will be assumed that on a corresponding display screen, a cursor is now disposed over an object such as an icon on the display screen. Now, a second finger makes touchdown on button 50 at location 62 and presses hard enough to activate the mechanical switch 46 disposed under the secondary sensor region 44. In this example, the function of the button 50 is to cause an object underneath a cursor on the display screen to be selected. In other words, the button 50 may operate as a commonly known left-click mouse button.

The touchpad sensor hardware determines where the finger has made touchdown in the secondary sensor region 44, and thus determines that button 50 has been activated. The object under the cursor on the display screen is now selected. While the second finger remains on button 50 and keeps the second mode of operation activated by applying a continuous force on the mechanical switch 46, the drag function can now be performed by the first finger. Thus, the first finger may now move from location 60 to anywhere else on the touchpad 40 such as location 64. The object will be dragged on the display screen in a corresponding movement.

The first finger, not on the button, can now be lifted off the surface of the primary sensor region 42 and the drag function is not terminated. The first finger could then make touchdown again anywhere within the primary sensor region 42 and then move across the surface, causing a corresponding movement of the object that is still selected on the display screen.

If the second finger is removed from the button 50 at any time, the object is de-selected on the display screen, and movement of the first finger will again only cause movement of the cursor, and not of the previously selected object.

Another embodiment of the present invention is to provide a third sensor region 48 as shown in FIG. 5. The third sensor region 48 also provides the function of a button region at the same time that the secondary sensor region 44 is providing this same function. Thus, another aspect of the invention is to be able to simultaneously provide multiple button regions.

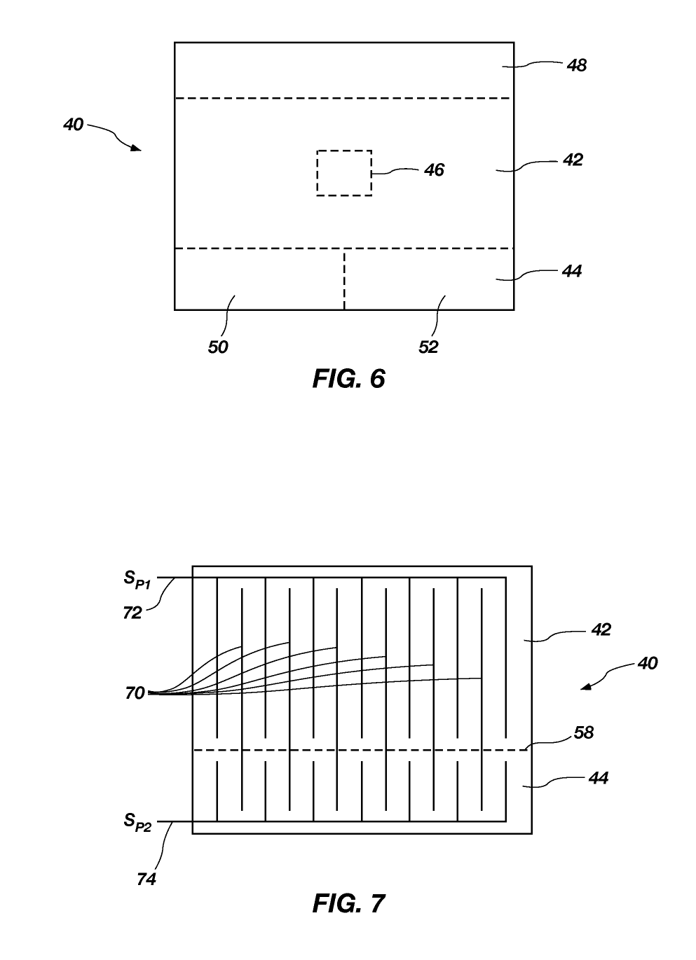

In another aspect of the invention as shown in FIG. 6, a mechanical switch 46 is approximately located under the center of the touchpad 40 so that pressing anywhere on the touchpad surface will enable activation of the mechanical switch 46. This is especially convenient if button regions are located on more than one side of a touchpad 40.

It should be remembered that once a finger stops pressing hard enough to activate the mechanical switch 46 or non-mechanical switch underneath the touchpad 40, the entire surface of the touchpad 40 including any button regions return to the general purpose function of the touchpad 40. Thus, movement anywhere on the surface of touchpad 40 would be detected and tracked in order to perform a typical touchpad function such as cursor control.

In this embodiment, no region is dedicated exclusively to button functionality. Instead, the button regions switch dynamically between functioning as button regions and general purpose regions, all depending upon whether or not a mechanical switch underneath the touchpad has been activated or toggled to be in an activated mode of operation.

Another feature of the present invention is that a finger resting hard enough on a touchpad to activate a mechanical switch underneath will not accidentally cause a two-finger or multi-finger gesture to be performed. This is only true when the entire bottom edge of the touchpad is being used as a button region.

Implementation of the present invention is possible using a single sensor circuit or multiple sensor circuits from Cirque® Corporation. In the case of using multiple sensor circuits, a processor must be provided to receive the signals from the multiple sensor circuits when each sensor circuit is dedicated to a separate region of the touchpad. The processor must be capable of operating the sensor regions so that the touchpad appears to operate as a single surface.

Alternatively, a sensor circuit from Cirque® Corporation does provide two separate sense lines. FIG. 7 shows a possible layout of such a touchpad 40. In this figure, a plurality of X electrodes 70 are shown as spanning the entire length of the touchpad 40. The exact number of X electrodes 70 is not shown. This figure is for illustration purposes only. Spaced apart from and interdigitated within the X electrodes 70 are two Sense lines, P1 72 and P2 74. This implementation only works when there are only two regions, a primary sensor region 42 and a secondary sensor or button region 44.

It should be understood that there are multiple ways to implement separate touchpad regions that can function as a single touchpad. The example shown in FIG. 7 is for illustration purposes only, and should not be considered as limiting.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A touchpad having two modes of operation that dynamically allocate regions of the touchpad for different functions, said touchpad comprised of:
a primary sensor region for the detection and tracking of movement a single conductive object on a surface thereof;
a secondary sensor region that is immediately adjacent to the primary sensor region; and
a switch disposed underneath the secondary sensor region, wherein the switch dynamically toggles the secondary sensor region between a first mode of operation and a second mode of operation, wherein a first mode of operation enables the secondary sensor region to perform detection and tracking of movement of the single conductive object as if seamlessly connected to the primary sensor region, and a second mode of operation that changes the secondary sensor region to a button mode of operation as long as the switch is activated.

2. The touchpad as defined in claim 1 wherein the switch is a mechanical switch that provide tactile feedback to a user when the switch is activated.

3. The touchpad as defined in claim 2 wherein the tactile feedback is a haptic sensation that is associated with the activation of a mechanical switch.

4. A method for dynamically altering operation of a touchpad by activating a switch, said method comprising the steps of:
1) providing a primary sensor region for the detection and tracking of movement a single conductive object on a surface thereof;
2) providing a secondary sensor region that is immediately adjacent to the primary sensor region;
3) providing a switch disposed underneath the secondary sensor region; and
4) dynamically switching between a first mode of operation and a second mode of operation by activating the switch, wherein a first mode of operation enables the secondary sensor region to perform detection and tracking of movement of the single conductive object as if seamlessly connected to the primary sensor region, and a second mode of operation that changes the secondary sensor region to a button mode of operation as long as the switch is activated.

5. The method as defined in claim 4 wherein the method further comprises the step of providing at least one function that is associated with the second mode of operation of the secondary sensor region when the switch is activated.

6. The method as defined in claim 5 wherein the method further comprises the steps of:
1) pressing down on the secondary sensor region with a first finger to activate the switch and activate the at least one function associated with the secondary sensor region; and
2) touching the primary sensor region with a second finger, and moving the second finger to perform the at least one function that is associated with the second mode of operation of the secondary sensor region.

7. The method as defined in claim 6 wherein the method further comprises the step of dividing the secondary sensor region into at least two buttons, wherein each of the at least two buttons provides a different function.
